(19) United States
(12) Patent Application Publication
(10) Pub. No.: US 2026/0342196 A1
(43) Pub. Date: Oct. 29, 2026

(54) VOICE COIL MOTOR

(71) Applicant: FANUC CORPORATION, Yamanashi (JP)

(72) Inventors: Yoshinori MURAKAMI, Minamitsuru-gun, Yamanashi (JP); Satoru KAWAI, Minamitsuru-gun, Yamanashi (JP); Toshiro HIGUCHI, Minamitsuru-gun, Yamanashi (JP)

(73) Assignee: FANUC CORPORATION, Yamanashi (JP)

(21) Appl. No.: 19/512,403

(22) PCT Filed: Sep. 12, 2023
(86) PCT No.: PCT/JP2023/033229

§ 371 Date: Feb. 19, 2026

(51) Int. Cl. H02K 41/035

(52) U.S. Cl. CPC H02K 41/0354

(57) ABSTRACT

A voice coil motor according to the present disclosure comprises: a cylindrical or columnar inner yoke; a cylindrical outer yoke surrounding the inner yoke so as to form a cylindrical gap between the inner yoke and itself; a cylindrical coil disposed in the gap; a magnet disposed inside the coil in a state of being in contact with the inner yoke, or disposed outside the coil in a state of being in contact with the outer yoke; a first connection yoke connecting one end in the axial direction of the inner yoke and one end in the axial direction of the outer yoke; and a second connection yoke connecting the other end in the axial direction of the inner yoke and the other end in the axial direction of the outer yoke. At least one of the first connection yoke and the second connection yoke has a plurality of yoke pieces arranged in a cylindrical shape so as to connect the inner yoke and the outer yoke. The plurality of yoke pieces are composed of separate members from the inner yoke and the outer yoke so as to be attached to the inner yoke and the outer yoke. A gap for taking out the output of the voice coil motor is provided between the adjacent yoke pieces.

### TECHNICAL FIELD

The present disclosure relates to a voice coil motor.

### BACKGROUND ART

A conventional voice coil motor has a configuration in which a solid circular columnar inner yoke and a circular cylindrical outer yoke are disposed so that a circular cylindrical clearance is formed therebetween, and one end portion of solid columnar inner yoke in the axial direction and one end portion of the cylindrical outer yoke in the axial direction are connected by a one-end-side connection yoke. The one-end-side connection yoke is integrally molded with the outer yoke, and blocks an opening at one end of the clearance in the axial direction. An opening at the other end of the clearance in the axial direction is open so that an output of a coil disposed to be movable in the axial direction in the clearance can be extracted.

In the case of a voice coil motor with the above configuration, in order to improve a thrust in the axial direction of the voice coil motor, it is suitable to connect the other end portion of the inner yoke in the axial direction and the other end portion of the outer yoke in the axial direction by an other-end-side connection yoke. The other-end-side connection yoke is integrally molded with the outer yoke, and blocks an opening at the other end of the clearance in the axial direction. However, since the other end of the clearance in the axial direction has to be open as mentioned above, the other-end-side connection yoke has a through hole for extracting the output of the coil. Typically, a coupling member penetrates the through hole of the other-end-side connection yoke so as to couple the coil and a drive part that is driven by an output of the voice coil motor.

When assembling the voice coil motor having the through hole, it is necessary to make the coupling member penetrate the through hole. Since the coupling member must be able to penetrate the through hole, it is necessary to design the coupling member in consideration of this point. That is, the coupling member used in the conventional voice coil motor has a low degree of freedom in design.

### CITATION LIST

### Patent Documents

Patent Document 1: Japanese Unexamined Patent Application, Publication No. 2000-23442

### DISCLOSURE OF THE INVENTION

### Problems to be Solved by the Invention

In order to solve the above-stated problem, a voice coil motor is desired that can improve a degree of freedom in design, while attempting an improvement of a thrust.

### Means for Solving the Problems

A voice coil motor of the present disclosure includes an inner yoke having a cylindrical or solid columnar shape, an outer yoke having a cylindrical shape and surrounding the inner yoke so as to form a cylindrical clearance between the outer yoke and the inner yoke, a coil having a cylindrical shape and disposed in the clearance, a magnet disposed inside the coil in a state of being in contact with the inner yoke or disposed outside the coil in a state of being in contact with the outer yoke, a first connection yoke connecting one end portion of the inner yoke in an axial direction and one end portion of the outer yoke in the axial direction, and a second connection yoke connecting an other end portion of the inner yoke in the axial direction and an other end portion of the outer yoke in the axial direction. At least one of the first connection yoke or the second connection yoke has a plurality of yoke pieces arranged in a cylindrical shape so as to connect the inner yoke and the outer yoke, the plurality of yoke pieces are composed of members separate from the inner yoke and the outer yoke so as to be attached to the inner yoke and the outer yoke, and a gap for extracting an output of the voice coil motor is provided between adjacent ones of the yoke pieces.

### BRIEF DESCRIPTION OF THE DRAWINGS

FIG. 1 is a schematic perspective view of a voice coil motor according to an embodiment of the present invention;

FIG. 2 is a cross-sectional view taken along A-A′ line in FIG. 1;

FIG. 3 is a cross-sectional view taken along B-B′ line in FIG. 2;

FIG. 4 is a cross-sectional view taken along line C-C′ in FIG. 3;

FIG. 5 is a schematic perspective view of a voice coil motor according to an embodiment of the present invention, and shows a state before yoke pieces are attached to an inner yoke and an outer yoke;

FIG. 6 is a schematic perspective view of a voice coil motor according to an embodiment of the present invention, and shows a state in which yoke pieces are being attached to an inner yoke and an outer yoke;

FIG. 7 is a schematic longitudinal section view showing a modified example 1 of a voice coil motor of the present invention; and

FIG. 8 is a schematic longitudinal section view showing a modified example 2 of a voice coil motor of the present invention.

### PREFERRED MODE FOR CARRYING OUT THE INVENTION

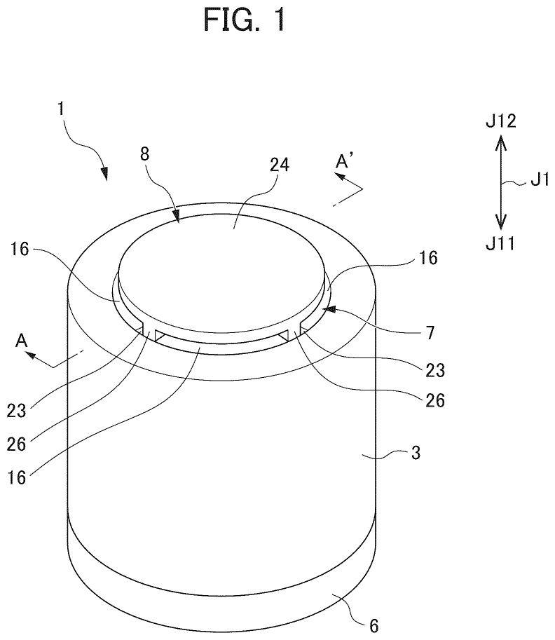

Hereinafter, a voice coil motor according to an embodiment of the present disclosure will be described by referring to the figures. A voice coil motor 1 according to the present embodiment will be described, by referring to FIGS. 1 to 6. The voice coil motor 1 includes an inner yoke 2, an outer yoke 3, a coil 4, a magnet 5, a first connection yoke 6, a second connection yoke 7, and a coupling member 8. Note that, hereinafter, an axial direction J1 is defined as an up-down direction. One end side in the axial direction J1 is defined as a lower side J11, and the other end side in the axial direction J1 is defined as an upper side J12.

The inner yoke 2 has a cylindrical or solid columnar shape. In the shown example, the inner yoke 2 has a solid circular columnar shape, and has an axial direction J1 along the up-down direction. The inner yoke 2 may have a cylindrical shape. In that case, the inner yoke 2 typically has a circular cylindrical shape.

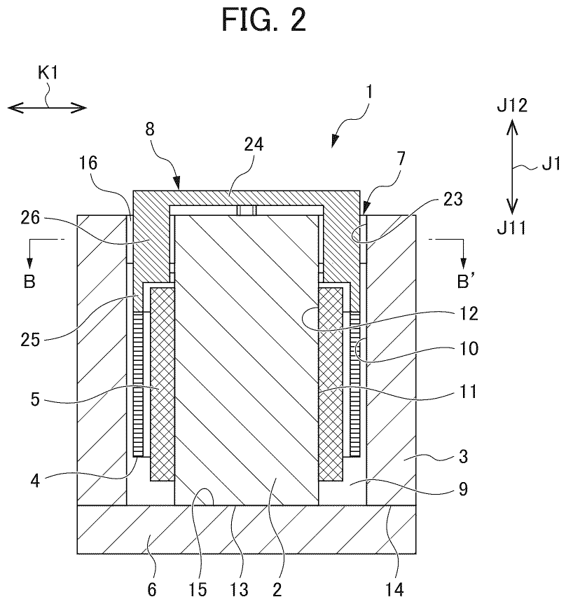

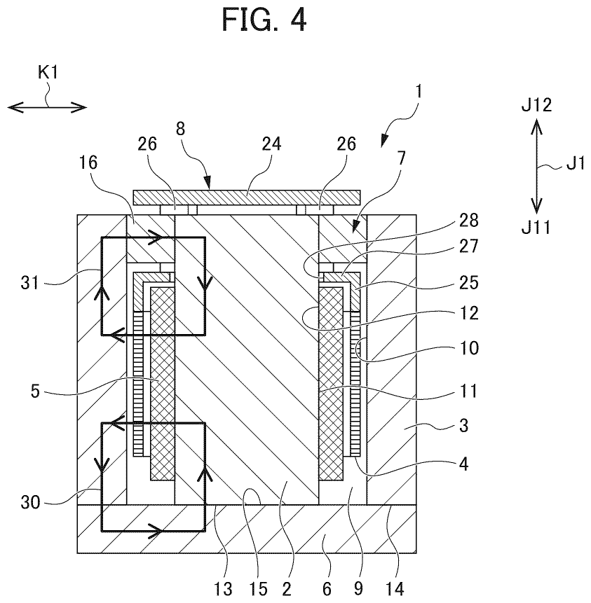

The outer yoke 3 has a cylindrical shape. In the shown example, the outer yoke 3 has a circular cylindrical shape, and has an axial direction J1 along the up-down direction. An inner diameter of the outer yoke 3 is larger than a diameter of the solid circular columnar inner yoke 2. As shown in FIGS. 2 and 4, the outer yoke 3 is disposed coaxially with the inner yoke 2 so as to surround the inner yoke 2. A cylindrical clearance 9 is formed between the outer yoke 3 and the inner yoke 2 in a state where the outer yoke 3 surrounds the inner yoke 2. The clearance 9 has a circular cylindrical shape, and is a space between an inner circumferential surface 10 of the outer yoke 3 and an outer circumferential surface 11 of the inner yoke 2. The circular cylindrical clearance 9 has an opening closer to the upper side J12 and open upwards, and an opening closer to the lower side J11 and open downwards.

The coil 4 is cylindrical. In the shown example, the coil 4 has a circular cylindrical shape, and has an axial direction J1 along the up-down direction. An inner diameter of the coil 4 is larger than the diameter of the inner yoke 2, and an outer diameter of the coil 4 is smaller than the inner diameter of the outer yoke 3. As shown in FIGS. 2 and 4, the coil 4 is disposed in the clearance 9 between the inner yoke 2 and the outer yoke 3 and positioned coaxially with the inner yoke 2 and the outer yoke 3.

The magnet 5 is cylindrical. In the shown example, the magnet 5 has a circular cylindrical shape, and has an axial direction J1 along the up-down direction. An outer diameter of the magnet 5 is smaller than an inner diameter of the coil 4. As shown in FIGS. 2 and 4, the magnet 5 is fixed to the inner yoke 2 in a state where the inner circumferential surface 12 of the magnet 5 and the outer circumferential surface 11 of the inner yoke 2 are in contact with each other. The magnet 5 is disposed coaxially with the inner yoke 2 and the outer yoke 3 in a state where the magnet 5 is fixed to the inner yoke 2. The magnet 5 is surrounded by the coil 4 disposed in the clearance 9 in the state where the magnet 5 is fixed to the inner yoke 2. In this way, the magnet 5 is disposed inside of the coil 4 while being in contact with the inner yoke 2. The magnet 5 of the present embodiment is a permanent magnet.

The first connection yoke 6 has a disk shape, and connects the inner yoke 2 and the outer yoke 3 at a position closer to the lower side J11 relative to the magnet 5 provided on the inner yoke 2. Specifically, the inner yoke 2 and the outer yoke 3 are fixed to the first connection yoke 6 in a state where a surface 13 of the inner yoke 2 closer to the lower side J11 and a surface 14 of the outer yoke 3 closer to the lower side J11 are in contact with a plate surface 15 of the first connection yoke 6 closer to the upper side J12. For example, the inner yoke 2 and the outer yoke 3 are fixed to the first connection yoke 6 by screws. The clearance 9 is formed between the inner yoke 2 and the outer yoke 3 in a state where the inner yoke 2 and the outer yoke 3 are fixed to the first connection yoke 6. In this way, the first connection yoke 6 connects one end portion of the inner yoke 2 in the axial direction J1 and one end portion of the outer yoke 3 in the axial direction J1.

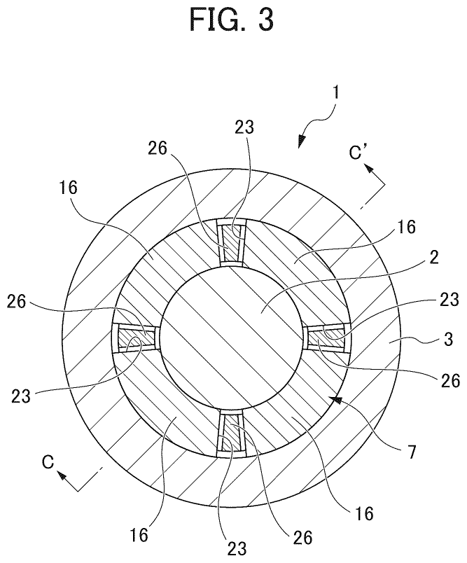

As shown in FIG. 3, the second connection yoke 7 has a plurality of yoke pieces 16 arranged in a cylindrical shape so as to connect the inner yoke 2 and the outer yoke 3. The plurality of yoke pieces 16 are composed of members separate from the inner yoke 2 and the outer yoke 3 so as to be attached to the inner yoke 2 and the outer yoke 3. In the shown example, each of the plurality of yoke pieces 16 has the shape of a substantially fan-shaped plate in a plan view. Specifically, each yoke piece 16 has a plate surface 17 located closer to the upper side J12, a plate surface 18 located closer to the lower side J11, and four end surfaces 19, 20, 21, and 22 each connecting the plate surface 17 located closer to the upper side J12 and the plate surface 18 located closer to the lower side J11.

The end surface 19 connects one end of the plate surface 17 in the circumferential direction and one end of the plate surface 18 in the circumferential direction. The end surface 20 connects the other end of the plate surface 17 in the circumferential direction and the other end of the plate surface 18 in the circumferential direction. The end surface 19 and the end surface 20 are inclined so as to separate from each other toward outside in a radial direction K1. In other words, a circumferential length between the end surface 19 and the end surface 20 increases toward outside in the radial direction K1. The end surface 21 connects an inside end of the plate surface 17 in the radial direction K1 and an inside end of the plate surface 18 in the radial direction K1. The end surface 22 connects an outside end of the plate surface 17 in the radial direction K1 and an outside end of the plate surface 18 in the radial direction K1. The end surface 21 is a curved surface that is concave in an arc shape toward the outside in the radial direction K1 in a plan view. The end surface 22 is a curved surface that is convex in an arc shape toward the outside in the radial direction K1 in a plan view.

The plurality of yoke pieces 16 are each provided between the inner yoke 2 and the outer yoke 3, at a position closer to the upper side J12 relative to the magnet 5 provided on the inner yoke 2. Specifically, the yoke piece 16 is fixed to the inner yoke 2 and the outer yoke 3 in a state where the end surface 21 of each yoke piece 16 is in contact with the outer circumferential surface 11 of the inner yoke 2 and in a state where the end surface 22 of each yoke piece 16 is in contact with the inner circumferential surface 10 of the outer yoke 3. For example, the yoke piece 16 is press fitted between the inner yoke 2 and the outer yoke 3, and is attached to the inner yoke 2 and the outer yoke 3 with an adhesive. In this way, the second connection yoke 7 connects the other end portion of the inner yoke 2 in the axial direction J1 and the other end portion of the outer yoke 3 in the axial direction J1.

In a state where the second connection yoke 7 is attached to the inner yoke 2 and the outer yoke 3, the end surface 22 of each yoke piece 16 is positioned closer to the outer yoke 3, and the end surface 21 of each yoke piece 16 is positioned closer to the inner yoke 2. Therefore, in each yoke piece 16, the end portion closer to the outer yoke 3 has a larger circumferential length than the end portion closer to the inner yoke 2. As stated above, the yoke pieces 16 are disposed between the inner yoke 2 and the outer yoke 3. Therefore, at the time of fixing the yoke pieces 16, the end surface 22 of each yoke piece 16 closer to the outer yoke 3 is brought into contact with the inner circumferential surface 10 of the outer yoke 3, and the end surface 21 of each yoke piece 16 closer to the inner yoke 2 is brought into contact with the outer circumferential surface 11 of the inner yoke 2.

Adjacent ones of the yoke pieces 16, 16 are not in contact with each other in a state where the second connection yoke 7 is attached to the inner yoke 2 and the outer yoke 3. In other words, the end surfaces 19, 20 of the adjacent yoke pieces 16, 16 are spaced apart from each other. Therefore, gaps 23 that penetrate in the up-down direction are provided between the adjacent yoke pieces 16, 16. The gaps 23 are for extracting an output of the voice coil motor 1. In the shown example, the coupling member 8, which couples the coil 4 and a drive part (not shown) that is driven by the output of the voice coil motor 1, passes through the gaps 23 between the adjacent yoke pieces 16, 16.

The coupling member 8 includes a drive part-side connection piece 24 positioned closer to the upper side J12, a motor-side connection piece 25 positioned closer to the lower side J11, and a plurality of connection pieces 26 connecting the drive part-side connection piece 24 and the motor-side connection piece 25. The drive part-side connection piece 24 has a disk shape, and is disposed with plate surfaces facing in the up-down direction. The drive part is connected to the drive part-side connection piece 24. The motor-side connection piece 25 has a short circular cylindrical shape and opens toward the lower side J11. An upper wall 27 of the motor-side connection piece 25 has a circular through hole 28 penetrating therethrough in the up-down direction. The coil 4 is supported on an end of the motor-side connection piece 25 closer to the lower side J11. In a state where the coil 4 is supported by the motor-side connection piece 25, the coil 4 has an axial direction J1 along the up-down direction. Each of the plurality of connection pieces 26 has a plate shape. An end of each connection piece 26 closer to the upper side J12 is connected to the drive part-side connection piece 24, and an end of each connection piece 26 closer to the lower side J11 is connected to the upper wall 27 of the motor-side connection piece 25.

The drive part-side connection piece 24 and the motor-side connection piece 25 are spaced apart from each other in the up-down direction in a state where the drive part-side connection piece 24 and the motor-side connection piece 25 are connected by the connection pieces 26. The plurality of connection pieces 26 are spaced apart from each other in a circumferential direction of the drive part-side connection piece 24 and a circumferential direction of the motor-side connection piece 25 in a state where the plurality of connection pieces 26 are connected to the drive part-side connection piece 24 and the motor-side connection piece 25. In other words, there is an interval between adjacent ones of the connection pieces 26, 26. Due to the configuration described above, the coupling member 8 has yoke-receiving cavities 29 each surrounded by the drive part-side connection piece 24, the upper wall 27 of the motor-side connection piece 25, and the adjacent connection pieces 26, 26. Each yoke-receiving cavity 29 is open toward the outside in the radial direction K1 of the drive part-side connection piece 24 and toward the outside in the radial direction K1 of the motor-side connection piece 25. The yoke pieces 16 are disposed in the yoke-receiving cavities 29. In the present embodiment, the coupling member 8 is a one-piece molding made of an appropriate material.

As shown in FIGS. 2 and 4, the coupling member 8 couples the drive part and the coil 4 in a state where the coupling member 8 penetrates the gaps 23. In this state where the connection pieces 26 of the coupling member 8 penetrate the gaps 23, the drive part-side connection piece 24 is positioned closer to the upper side J12 relative to the second connection yoke 7, and the motor-side connection piece 25 is positioned inside the clearance 9 and closer to the lower side J11 relative to the second connection yoke 7. The coil 4 is provided at the end of the motor-side connection piece 25 closer to the lower side J11 such that the coil 4 extends toward the lower side J11. The coil 4 is disposed between the outer yoke 3 and the magnet 5 provided on the inner yoke 2 in a state where the coil 4 is supported on the motor-side connection piece 25.

The voice coil motor 1 with the above described configuration can move the coil 4 in the axial direction J1 by energizing to the coil 4. Moving the coil 4 in the axial direction J1 causes the coupling member 8 supported by the coil 4 to move in the axial direction J1. Thus, the voice coil motor 1 can drive the drive part connected to the coupling member 8.

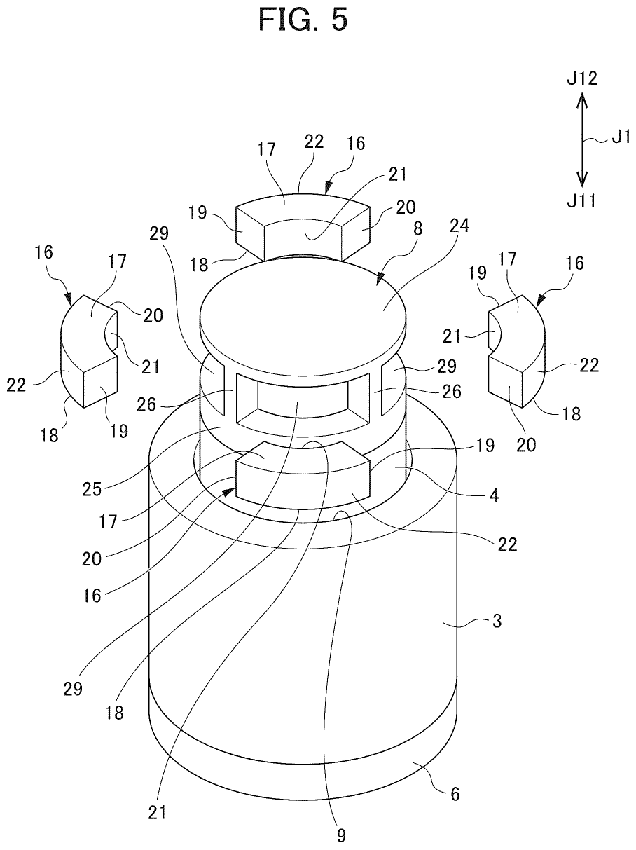

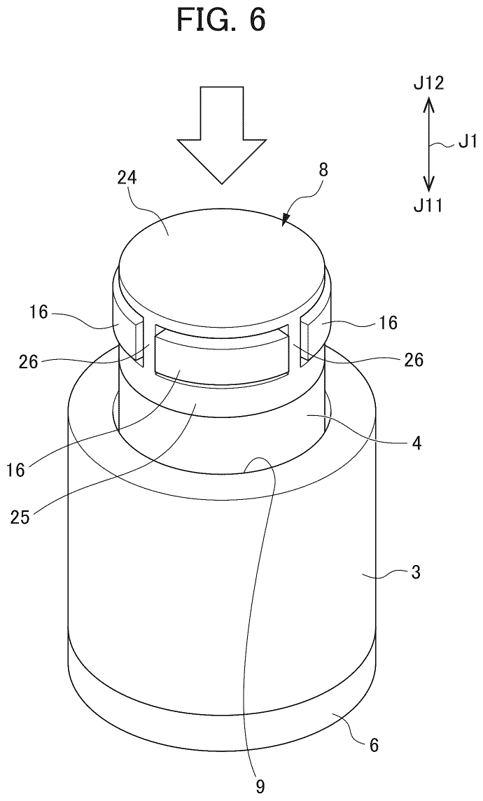

Next, manufacture of the voice coil motor 1 of the present embodiment will be described with reference to FIGS. 5 and 6. In order to manufacture the voice coil motor 1, first, the outer yoke 3 and the inner yoke 2 are fixed to the first connection yoke 6, and the magnet 5 is fixed to the inner yoke 2. In the shown example, the outside of the magnet 5 in the radial direction K1 is an N pole, and the inside of the magnet 5 in the radial direction K1 is an S pole. Thereafter, the yoke pieces 16 are inserted from the outside in the radial direction K1 into the yoke-receiving cavities 29 of the coupling member 8 supported by the coil 4. The yoke pieces 16 are temporarily fastened to the coupling member 8 in a state where the yoke pieces 16 have been inserted into the yoke-receiving cavities 29. In this state where the yoke pieces 16 have been inserted into the yoke-receiving cavities 29, the coil 4 supported by the coupling member 8 is inserted into the clearance 9 through the opening of the clearance 9 closer to the upper side J12. After the coil 4 is inserted into the clearance 9, the yoke pieces 16 are fixed to the inner yoke 2 and the outer yoke 3. In the state where the yoke pieces 16 have been fixed to the inner yoke 2 and the outer yoke 3, the inner yoke 2 penetrates the through hole 28 of the coupling member 8. Note that in the state where the yoke pieces 16 are temporarily fastened to the coupling member 8, the yoke piece 16 and the outer yoke 3 are preferably in a positional relationship in which the end surfaces 22 of the yoke pieces 16 come into contact with the inner circumferential surface 10 of the outer yoke 3 when the coupling member 8 is moved toward the lower side J11. In this way, the voice coil motor 1 of the present embodiment is manufactured.

The voice coil motor 1 of the present embodiment includes the first connection yoke 6 and the second connection yoke 7. Therefore, as shown in FIG. 4, the voice coil motor 1 includes a magnetic circuit 30 that is formed by the inner yoke 2, the outer yoke 3, and the first connection yoke 6 and a magnetic circuit 31 that is formed by the inner yoke 2, the outer yoke 3, and the second connection yoke 7. Therefore, according to the voice coil motor 1 of the present embodiment, a thrust of the coil 4 can be improved. Moreover, in the case of the voice coil motor 1 of the present embodiment, the second connection yoke 7 is attached to the inner yoke 2 and the outer yoke 3. Therefore, according to the voice coil motor 1 of the present embodiment, it is not necessary to make the coupling member 8 penetrate the second connection yoke 7 that has been attached to the inner yoke 2 and the outer yoke 3, thereby improving a degree of freedom in design of the coupling member 8.

In the case of the voice coil motor 1 of the present embodiment, since each yoke piece 16 has the shape of a substantially fan-shaped plate in a plan view, in each yoke piece 16, the end portion closer to the outer yoke 3 has a larger circumferential length than the end portion closer to the inner yoke 2. Therefore, according to the voice coil motor 1 of the present embodiment, a largest circumferential length from among circumferential lengths of each gap 23 is smaller than a radial length of the gap 23, whereby a cross-section area of each gap 23 can be ensured, while suppressing a situation in which a flow of magnetic flux is hindered by each gap 23. Ensuring the cross-section area of each gap 23 leads to thickening the connection pieces 26 of the coupling member 8, thereby enabling an increase in a strength of the coupling member 8.

In the case of the voice coil motor 1 of the present embodiment, the coupling member 8 is a one-piece molding. Therefore, according to the voice coil motor 1 of the present embodiment, a rigidity of the coupling member 8, which is a movable member, can be improved. As a result, shaking of the coupling member 8 at the time of movement can be suppressed, whereby an improvement in the performance of the voice coil motor 1 can be attempted. Moreover, in the case of the voice coil motor 1 of the present embodiment, the coupling member 8 has the yoke-receiving cavities 29 into which the yoke pieces 16 are inserted. As a result, at the time of manufacturing the voice coil motor 1, the yoke pieces 16 can be attached to the inner yoke 2 and the outer yoke 3 in a state where the yoke pieces 16 have been inserted into the yoke-receiving cavities 29. Therefore, according to the voice coil motor 1 of the present embodiment, ease of assembly of the voice coil motor 1 can be ensured.

According to the above-stated embodiment, the voice coil motor 1 includes the first connection yoke 6 and the second connection yoke 7 that includes the plurality of yoke pieces 16 as members separate from the inner yoke 2 and the outer yoke 3, and the gaps 23 are provided between adjacent ones of the yoke pieces 16, 16. Therefore, the voice coil motor 1 can be provided which can improve a degree of freedom in design, while attempting an improvement in a thrust.

While the present disclosure is described in detail, the present disclosure is not limited to the above-described embodiment. Various additions, substitutions, modifications, and partial deletions may be made to the embodiment in a range that does not deviate from the spirit of the present disclosure, or in a range that does not deviate from the content of the present disclosure derived from the content described in the claims and equivalent thereof. In the above-described embodiment, the order of operations and the order of processing are described as non-limiting examples. The same applies to a case in which numerals or formulas are used in the description of the above embodiment.

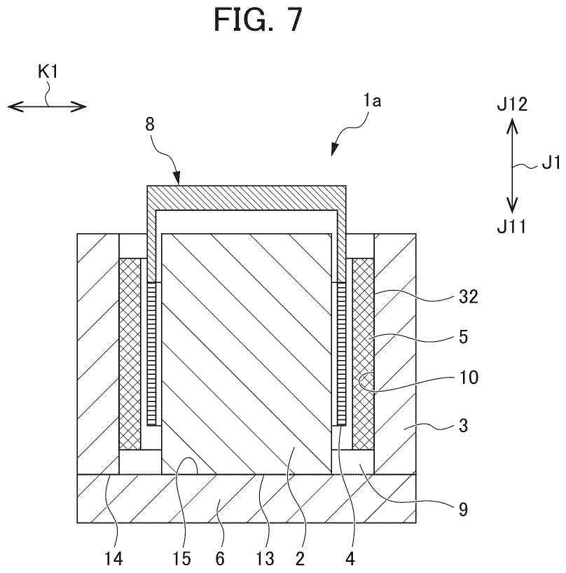

For example, the magnet 5 may be provided on the outer yoke 3, as in modified example 1 shown in FIG. 7. Note that since constituent elements denoted by the same reference numerals as those used in the above embodiment have the same functions, a description thereof may be omitted hereinafter.

In a case of a voice coil motor 1a of modified example 1, an inner diameter of the circular cylindrical magnet 5 is larger than an outer diameter of the coil 4. As shown in FIG. 7, the magnet 5 is fixed to the outer yoke 3 in a state where the outer circumferential surface 32 of the magnet 5 and the inner circumferential surface 10 of the outer yoke 3 are in contact with each other. In the shown example, the outside of the magnet 5 in the radial direction K1 is an N pole, and the inside of the magnet 5 in the radial direction K1 is an S pole. The coil 4 disposed in the clearance 9 is surrounded by the magnet 5 in a state where the magnet 5 is fixed to the outer yoke 3. In other words, the coil 4 is disposed between the inner yoke 2 and the magnet 5 fixed to the outer yoke 3. In this way, the magnet 5 is disposed outside the coil 4 in a state where the magnet 5 is in contact with the outer yoke 3.

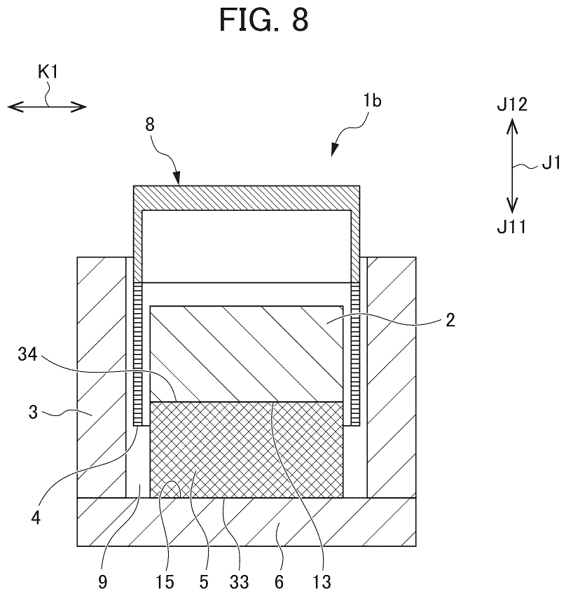

Moreover, the magnet 5 and the inner yoke 2 may be configured as in modified example 2 shown in FIG. 8. Note that since constituent elements denoted by the same reference numerals as those used in the above embodiment have the same functions, a description thereof may be omitted hereinafter.

In the case of a voice coil motor 1b of modified example 2, the magnet 5 has a solid columnar shape. In the shown example, the solid circular columnar magnet 5 has an axial direction J1 along the up-down direction. The magnet 5 is fixed to the first connection yoke 6. Specifically, the magnet 5 is fixed to the first connection yoke 6 in a state where a surface 33 of the magnet 5 closer to the lower side J11 is in contact with the plate surface 15 of the first connection yoke 6 closer to the upper side J12. The magnet 5 extends from the first connection yoke 6 toward the upper side J12 in a state where the magnet 5 is fixed to the first connection yoke 6. The magnet 5 is disposed coaxially with the outer yoke 3 in a state where the magnet 5 is fixed to the first connection yoke 6. Note that a portion of the magnet 5 closer to the upper side J12 is an N pole, and a portion of the magnet 5 closer to the lower side J11 is an S pole.

In the case of the voice coil motor 1b of modified example 2, the inner yoke 2 has a solid columnar shape. In the shown example, the solid circular columnar inner yoke 2 has an axial direction J1 along the up-down direction. The inner yoke 2 is fixed to the first connection yoke 6 via the magnet 5. Specifically, the inner yoke 2 is fixed to the magnet 5 in a state where the surface 13 of the inner yoke 2 closer to the lower side J11 is in contact with a surface 34 of the magnet 5 closer to the upper side J12. The inner yoke 2 is disposed coaxially with the magnet 5 and the outer yoke 3 in a state of being fixed to the first connection yoke 6.

The diameter of the inner yoke 2 and the diameter of the magnet 5 are smaller than the inner diameter of the outer yoke 3. Therefore, the circular cylindrical clearance 9 that is continuous in the up-down direction is formed between the inner yoke 2 and the outer yoke 3 and between the magnet 5 and the outer yoke 3. The coil 4 supported by the coupling member 8 is disposed in the clearance 9. The coil 4 is disposed coaxially with the inner yoke 2 and the outer yoke 3.

In the above-described embodiment, from among the first connection yoke 6 and the second connection yoke 7, the second connection yoke 7 has the plurality of yoke pieces 16. However, from among the first connection yoke 6 and the second connection yoke 7, the first connection yoke 6 may have a plurality of yoke pieces 16, or both the first connection yoke 6 and the second connection yoke 7 may have a plurality of yoke pieces 16. In other words, at least one of the first connection yoke 6 or the second connection yoke 7 may have the plurality of yoke pieces 16 arranged in a cylindrical shape so as to connect the inner yoke 2 and the outer yoke 3.

In the above-described embodiment, each gap 23 has the shape of a substantially fan-shaped plate in a plan view, as a non-limiting example. Each gap 23 may have, for example, a rectangular shape in a plan view or a circular shape in a plan view. In that case, the inner yoke 2, the outer yoke 3, and the yoke pieces 16 have respective suitable shapes.

The following further discloses additional remarks regarding the foregoing embodiment.

### Additional Remark 1

A voice coil motor (1) includes an inner yoke (2) having a cylindrical or solid columnar shape, an outer yoke (3) having a cylindrical shape and surrounding the inner yoke (2) so as to form a cylindrical clearance (9) between the outer yoke (3) and the inner yoke (2), a coil (4) having a cylindrical shape and disposed in the clearance (9), a magnet (5) disposed inside the coil (4) in a state of being in contact with the inner yoke (2) or disposed outside the coil (4) in a state of being in contact with the outer yoke (3), a first connection yoke (6) connecting one end portion of the inner yoke (2) in an axial direction (J1) and one end portion of the outer yoke (3) in the axial direction (J1), and a second connection yoke (7) connecting an other end portion of the inner yoke (2) in the axial direction (J1) and an other end portion of the outer yoke (3) in the axial direction (J1). At least one of the first connection yoke (6) or the second connection yoke (7) has a plurality of yoke pieces (16) arranged in a cylindrical shape so as to connect the inner yoke (2) and the outer yoke (3), the plurality of yoke pieces (16) are composed of members separate from the inner yoke (2) and the outer yoke (3) so as to be attached to the inner yoke (2) and the outer yoke (3), and a gap (23) for extracting an output of the voice coil motor (1) is provided between adjacent ones of the yoke pieces (16, 16).

### Additional Remark 2

In the voice coil motor (1) according to Additional Remark 1, it is preferable that in each of the plurality of yoke pieces (16), an end portion closer to the outer yoke (3) has a larger circumferential length than an end portion closer to the inner yoke (2).

### Additional Remark 3

In the voice coil motor (1) according to Additional Remark 1 or 2, it is preferable that an end surface (22) of each yoke piece (16) closer to the outer yoke (3) is in contact with an inner circumferential surface (10) of the outer yoke (3), and an end surface (21) of each yoke closer to the inner yoke (2) is in contact with an outer circumferential surface (11) of the inner yoke (2).

### Additional Remark 4

Preferably, the voice coil motor (1) according to any one of Additional Remarks 1 to 3 further includes a coupling member (8) that couples the coil (4) to a drive part configured to be driven by an output of the voice coil motor (1) in a state where the coupling member (8) penetrates the gap (23), and the coupling member (8) has yoke-receiving cavities (29) in which the yoke pieces (16) are disposed and is composed of a one-piece molding.

### EXPLANATION OF REFERENCE NUMERALS

1 voice coil motor
2 inner yoke
3 outer yoke
4 coil
5 magnet
6 first connection yoke
7 second connection yoke
8 coupling member
9 clearance
10 inner circumferential surface of outer yoke
11 outer circumferential surface of inner yoke
16 yoke piece
21 end surface of yoke piece
22 end surface of yoke piece
23 gap
29 yoke-receiving cavity

1. A voice coil motor comprising:
an inner yoke having a cylindrical or solid columnar shape;
an outer yoke having a cylindrical shape and surrounding the inner yoke so as to form a cylindrical clearance between the outer yoke and the inner yoke;
a coil having a cylindrical shape and disposed in the clearance;
a magnet disposed inside the coil in a state of being in contact with the inner yoke or disposed outside the coil in a state of being in contact with the outer yoke;
a first connection yoke connecting one end portion of the inner yoke in an axial direction and one end portion of the outer yoke in the axial direction; and
a second connection yoke connecting an other end portion of the inner yoke in the axial direction and an other end portion of the outer yoke in the axial direction, wherein
at least one of the first connection yoke or the second connection yoke has a plurality of yoke pieces arranged in a cylindrical shape so as to connect the inner yoke and the outer yoke,
the plurality of yoke pieces are composed of members separate from the inner yoke and the outer yoke so as to be attached to the inner yoke and the outer yoke, and
a gap for extracting an output of the voice coil motor is provided between adjacent ones of the yoke pieces.

2. The voice coil motor according to claim 1, wherein in each yoke piece, an end portion of closer to the outer yoke has a larger circumferential length than an end portion closer to the inner yoke.

3. The voice coil motor according to claim 1, wherein an end surface of each yoke piece closer to the outer yoke is in contact with an inner circumferential surface of the outer yoke, and an end surface of each yoke piece closer to the inner yoke is in contact with an outer circumferential surface of the inner yoke.

4. The voice coil motor according to claim 1, further comprising:
a coupling member that couples the coil to a drive part configured to be driven by an output of the voice coil motor in a state where the coupling member penetrates the gap, wherein
the coupling member has yoke-receiving cavities in which the yoke pieces are disposed, and is composed of a one-piece molding.
